(19) United States
(12) Patent Application Publication
(10) Pub. No.: US 2024/0060328 A1
(43) Pub. Date: Feb. 22, 2024

(54) CANOPY WITH AESTHETIC SCREENS

(71) Applicant: Jeffrey De Ponte, Fresno, CA (US)

(72) Inventor: Jeffrey De Ponte, Fresno, CA (US)

(21) Appl. No.: 17/957,615

(22) Filed: Sep. 30, 2022

Related U.S. Application Data
(60) Provisional application No. 63/399,007, filed on Aug. 18, 2022.

(51) Int. Cl. E04H 15/58

(52) U.S. Cl. CPC E04H 15/58; G09F 19/227

(57) ABSTRACT

A canopy with printable mesh windows and door. The canopy can be used for a food booth, vendor booth, and the like. Suitable designs and advertisements can be printed on the printable mesh.

### CROSS-REFERENCE TO RELATED APPLICATIONS

This application claims priority from a U.S. Provisional Patent Appl. No. 63/399,007 filed on Aug. 18, 2022, which is incorporated herein by reference in its entirety.

### FIELD OF INVENTION

The present invention relates to canopies and tents, and more particularly, the present invention relates to canopies with aesthetic mesh windows.

### BACKGROUND

Temporary structures in the form of canopies and tents are quite popular for exhibitions, promotion events, festivals, fairs, and the like events. Food booth canopies are quick to set up and are used for serving food in public places. The main purpose of the canopy is to protect the external environment and extraneous matter, however, the canopy also provides a good amount of surface for advertisement. Advertisements are generally provided on both the inner and outer walls of canopies.

Canopies for certain purposes or in certain environments are required to be fully enclosed and have large windows and doors. The windows can be covered with screens to prevent the ingress of insects while providing sufficient ventilation. Similarly, the door can also be made from mesh. For example, food booth canopies have large mesh windows for a good amount of ventilation, serving food, and preventing ingress of extraneous matter including insects. However, the large area occupied by the mesh is unutilized and does not appear aesthetic.

A need is therefore appreciated for novel canopy designs and methods in which the surface area of mesh can be utilized.

The term canopy and tent are interchangeably used hereinafter. The terms mesh and screen are also used interchangeably herein.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is thereof directed to a canopy with printable mesh windows and/or doors.

It is another object of the present invention that advertisements can be printed on the mesh.

It is a further object of the present invention that the canopy is for food booths.

It is yet another object of the present invention that the canopy is for vendor booths.

In one aspect, disclosed is a canopy including a roof, walls, one or more windows in the walls, printable mesh fabric is sewn to peripheries of the one or more windows to cover the one or more windows. The canopy further comprises a door made from printable mesh fabric. The printable mesh fabric has a design printed thereon. The roof and walls are made from fabric. The fabric is flame resistant or has a layer of flame-resistant material. The fabric has UV resistant coating and a waterproofing layer. The canopy is for a vendor booth, food booth, and the like.

In one aspect, disclosed is a method for manufacturing a canopy, the method includes providing roof and walls of the canopy, wherein the walls have one or more windows; cover the one or more windows with printable mesh fabric, and printing designs over the printable mesh fabric. The printable mesh fabric is sewn to peripheries of the one or more windows. The method further comprises providing a door made from printable mesh fabric. The printable mesh fabric has a design printed thereon. The roof and walls are made from fabric. The fabric is flame resistant or has a layer of flame-resistant material. The fabric has UV resistant coating and a waterproofing layer. The canopy is for a vendor booth. The canopy is for a food booth, the canopy further has a food serving window at front of the canopy, the food serving window is made from the printable mesh fabric.

### BRIEF DESCRIPTION OF THE DRAWINGS

The accompanying FIGURES, which are incorporated herein, form part of the specification and illustrate embodiments of the present invention. Together with the description, the FIGURES further explain the principles of the present invention and to enable a person skilled in the relevant arts to make and use the invention.

FIG. 1 is a perspective view of a canopy with printable mesh windows, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form to facilitate describing the subject innovation. Moreover, the drawings may not be to scale.

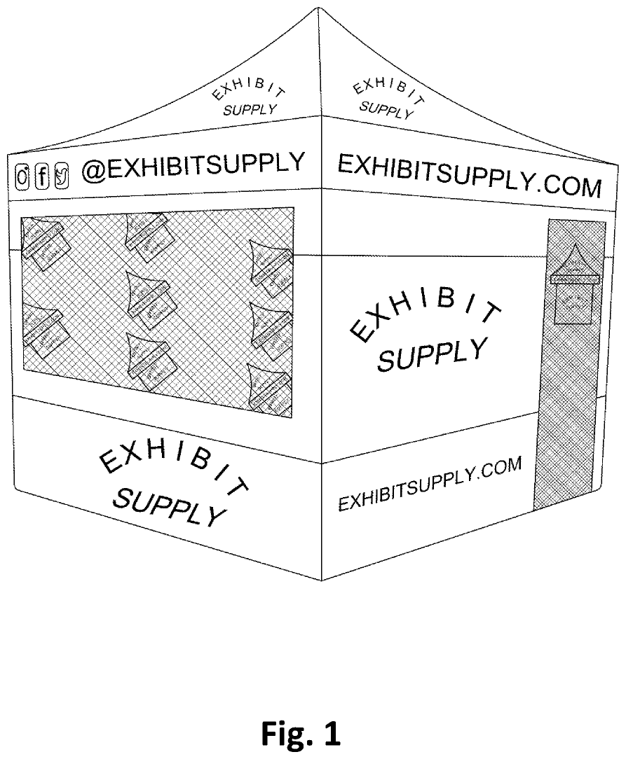

Disclosed is a canopy with printable mesh windows and/or doors. Referring to FIG. 1 shows an exemplary embodiment of the canopy with printable mesh windows and door. The canopy includes an enclosure that has side walls and a roof. The side walls have one or more windows that may span two or more adjacent side walls. A door can also be provided in one of the sidewalls. It is understood that the number of windows and doors, the shape of the windows and door, and the position of the windows and door in a canopy can be varied without departing from the scope of the present invention. The canopies of different sizes, shapes, and designs can be provided for different purposes, such as for food booths and vendor booths. The walls and roof are made from fabric. Optionally, a layer of UV-resistant material can be provided on the fabric for walls and roofs. Moreover, the fabric can be made from fire retardant/fire resistant/flame resistant materials. Alternatively, a layer of fire retardant/fire resistant/flame resistant material can be provided on the fabric. It is understood that the type of fabric used and protective layers on the fabric for walls and doors may depend upon the intended use of the canopy, and any material can be used for fabric and layers without departing from the scope of the present invention. The canopies intended for use in an open environment can also be provided with a layer of waterproofing. For example, a canopy for a food product may have a layer of UV-resistant material and preferably the material is flame-resistant material. A suitable certification for fire retardant/fire resistant/flame resistant can also be provided with the canopy, wherein such a certification can be applied on the wall of the canopy for inspection.

The disclosed canopy includes printable mesh fabric that can be sewn to the periphery of the windows of the canopy. The printable mesh fabric can cover the windows to prevent the ingress of insects and extraneous matter. The printable mesh allows printing designs and advertisement over it. The resultant canopy with printable mesh fabric on which designs are printed looks more aesthetic than conventional canopies. Moreover, printable mesh fabric provides an additional surface for advertising and thus efficient utilization of the majority surface of the canopy. Similar, to windows, the mesh doors of conventional canopies can be replaced by the disclosed printable mesh. The canopies for food booths can have one or more food serving windows with covers made from printable mesh fabric. For example, the canopy can be provided with a food service window in the front. The covers for the food serving window can include hook and loop fastener strips. Designs can be printed on the printable mesh fabric of the food serving windows.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A canopy comprising:
a roof;
walls;
one or more windows in the walls; and
printable mesh fabric is sewn to peripheries of the one or more windows to cover the one or more windows.

2. The canopy according to claim 1, wherein the canopy further comprises a door made from printable mesh fabric.

3. The canopy according to claim 1, wherein the printable mesh fabric has a design printed thereon.

4. The canopy according to claim 1, wherein the roof and walls are made from fabric.

5. The canopy according to claim 4, wherein the fabric is flame resistant or has a layer of flame-resistant material.

6. The canopy according to claim 4, wherein the fabric has UV resistant coating.

7. The canopy according to claim 4, wherein the fabric has a waterproofing layer.

8. The canopy according to claim 1, wherein the canopy is for a vendor booth.

9. The canopy according to claim 1, wherein the canopy is for a food booth.

10. A method for manufacturing a canopy, the method comprises:
providing roof and walls of the canopy, wherein the walls have one or more windows;
cover the one or more windows with printable mesh fabric, and
printing designs over the printable mesh fabric.

11. The method according to claim 10, wherein the printable mesh fabric is sewn to peripheries of the one or more windows.

12. The method according to claim 10, wherein the method further comprises providing a door made from printable mesh fabric.

13. The method according to claim 10, wherein the printable mesh fabric has a design printed thereon.

14. The method according to claim 10, wherein the roof and walls are made from fabric.

15. The method according to claim 14, wherein the fabric is flame resistant or has a layer of flame-resistant material.

16. The method according to claim 14, wherein the fabric has UV resistant coating.

17. The method according to claim 14, wherein the fabric has a waterproofing layer.

18. The method according to claim 14, wherein the canopy is for a vendor booth.

19. The method according to claim 14, wherein the canopy is for a food booth, the canopy further has a food serving window at front of the canopy, the food serving window is made from the printable mesh fabric.
